(19) United States
(12) Patent Application Publication
(10) Pub. No.: US 2015/0334164 A1
(43) Pub. Date: Nov. 19, 2015

(54) APPARATUS AND METHOD FOR SEAMLESS DATA TRANSFER TO A CLOUD NETWORK

(71) Applicant: GE Intelligent Platforms, Inc., Charlottesville, VA (US)

(72) Inventors: Kenneth Wayne CRAWFORD, Charlottesville, VA (US); Stephen PAVLOSKY, Charlottesville, VA (US)

(73) Assignee: GE Intelligent Platforms, Inc., Charlottesville, VA (US)

(21) Appl. No.: 14/277,128

(22) Filed: May 14, 2014

(51) Int. Cl. H04L 29/08; G05B 19/05

(52) U.S. Cl. CPC H04L 67/10; G05B 19/054

(57) ABSTRACT

A seamless and secure communication path from a control network to a cloud server is created. The network is coupled to one or more control devices. Tag information from a control network is obtained. The tag information includes one or more programmed variables associated with the one or more control devices controlled by a control system. The tag information is seamlessly and automatically uploaded from the control network to the cloud server via the seamless communication path according to at least one predetermined criteria.

### BACKGROUND OF THE INVENTION

1. Field of the Invention

The subject matter disclosed herein relates to cloud networks and control networks and, more specifically, exchanging data and information between cloud networks and control networks.

2. Brief Description of the Related Art

Cloud networks exist and are used in today's computing environment. The cloud network (also referred to simply as “the cloud”) can be accessed by other devices such as computers or cellular phones. The cloud networks can be used to store information for various users.

Control systems also exist in today's marketplace and in many different environments. For example, a control system may provide functionality relating to controlling an oil refinery or a nuclear power plant (or devices within these installations). Various types of control devices are used within the control system to actuate or otherwise control the control devices. Also, various sensors within the control system (e.g., coupled to a control device) and these sensors may obtain and report the configuration or readings of various conditions that exist within the control system or the devices within the control system.

In previous systems, there is no one single device or apparatus that automatically gathers process data from a control system or network, securely transfers that data to the cloud, and enables various types of processing or storage functions. The processing and storage functions may include enterprise-level functionality such as historian services, predictive analytics, or trending alarms to mention a few examples. The inability to provide a single and streamlined approach in these regards has created dissatisfaction with these previous approaches.

### BRIEF DESCRIPTION OF THE INVENTION

The approaches described herein provide a single device that can retrieve control network data (e.g., programmable logic controller (PLC) variable data) and transfer the data to the cloud. In some aspects, a historian is provided (through a secure encrypted connection), thereby enabling archived, historized, time stamped, buffered, store/forward data with alarming and trending capabilities without the need for altering any existing PLC programs or special PLC drivers.

The present approaches can connect a control system and cloud network through, for example, traditional LAN or cellular networks thereby circumventing internal firewalls allowing a direct machine-to-cloud connection outside of the normal traditional information technology (IT) infrastructure. In one advantage, the present approaches greatly reduce the efforts required on the client side by not requiring IT resources or skilled resources or cross functional resources in order to install device. In another advantage, significant cost/time-to-value savings for customers are achieved.

In one aspect, all processing and analytics are performed at the cloud. The data is stored locally in a single device apparatus and forwarded to the cloud for post-processing analytics and historization.

In many of these embodiments, a seamless and secure communication path from a control network to a cloud server is created. The network is coupled to one or more control devices. Tag information from a control network is obtained. The tag information includes one or more programmed variables associated with the one or more control devices controlled by a control system. The tag information is seamlessly and automatically uploaded from the control network to the cloud server via the seamless communication path according to at least one predetermined criteria.

In some examples, the predetermined criteria may be a time frequency to upload the information, or a time of day to upload the information. Other examples are possible.

In other aspects, the information is received at the cloud server, the data is evaluated, and an action is taken based upon the evaluating. In some examples, the action may be sending an email, generating a report, or issuing an alarm message. Other examples of actions are possible.

In some aspects, the variables include a variable associated with a machine characteristic. The machine characteristics may be temperatures, pressures, frequencies, times, yields, electrical characteristics, or machine states to mention only a few examples. Other examples are possible.

In other aspects, the cloud server is configured to be accessible to users via an internet connection. In other example, the tag information includes a time stamp.

In some examples, the seamless and secure connection utilizes at least one of a cellular connection, a Wi-Fi connection, and Ethernet connection, a local area network (LAN) connection, or a cable. In other examples, a set of criteria to select the tag information may be manually configured (or in other examples automatically configured) and the tag information obtained according to the criteria. In still other examples, the criteria may be a number of tags to obtain information and a frequency for how often the information is to be obtained.

In others of these embodiments, an apparatus that is configured to seamlessly upload tag information from a control network to a cloud server includes a control network interface, a secure cloud interface, and a processor. The processor is coupled to the control network interface and the secure cloud interface. The processor is configured to create a seamless and secure communication path from the control network to the cloud server. The control network is coupled to one or more control devices. The processor is configured to obtain tag information from the control network via the control network interface. The tag information includes one or more programmed variables associated with the one or more control devices controlled by a control system. The processor is further configured to seamlessly and automatically upload the tag information from the control network to the cloud server via the seamless communication path created through a secure cloud interface according to at least one predetermined criteria.

### BRIEF DESCRIPTION OF THE DRAWINGS

For a more complete understanding of the disclosure, reference should be made to the following detailed description and accompanying drawings wherein:

FIG. 1 comprises a block diagram of a system for uploading control data to a cloud according to various embodiments of the present invention;

FIG. 2 comprises a flow chart of an approach for uploading control data to a cloud according to various embodiments of the present invention;

FIG. 3 comprises chart showing information flow between devices in a system that uploads control data from a control system to a cloud according to various embodiments of the present invention; and

FIG. 4 comprises a block diagram of an access device according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Approaches are provided that automatically retrieve programmable logic controller (PLC) variable data (and other types of control data) and transfer the data to a cloud. Historian functionality through a secure encrypted connection is provided thereby enabling archived, historized, time-stamped, buffered, store/forward data with alarming and trending capabilities without the need for altering any existing PLC programs or providing special PLC drivers.

In one advantage, no users (e.g., a sales team) are required to demonstrate the approaches because data is automatically uploaded to the cloud network. In another advantage, no IT resources are required to perform the uploading since the device described herein provides the functionality. In another advantage, wizard driven requirements can be sold online. As used herein, a “wizard” is a feature that asks configuration questions to a user in order to automate what would otherwise be time-consuming and/or difficult tasks. In still another advantage, significant time-to-value savings are achieved. As used herein, “time-to-value” savings refer to reducing the time investment as measured from the launching of an initiative to the realization and reward of the desired outcome.

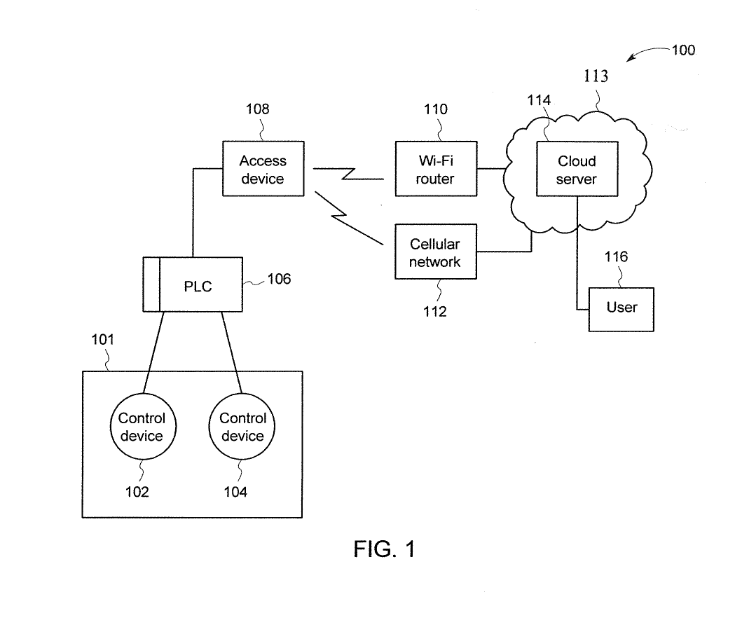

Referring now to FIG. 1, a system 100 for seamlessly uploading tag information from a control network 101 to a cloud server 114 is described. The control network 101 includes a first control device 102, and second control device 104. The system 100 further includes a programmable logic controller (PLC) 106, an access device 108, a Wi-Fi router 110, a cellular network 112, a cloud network 113, the cloud server 114, and a user 116.

The control network 101 includes a first control device 102 and a second control device 104. The control devices 102 and 104 may be configured to provide any type of control functionality. For example, the control devices 102 and 104 may operate switches, actuate valves, or activate/deactivate devices. The control devices 102 and 104 may be coupled together in a control network 101 with any network topology or using any type of network or combination of networks. The control network 101 may be disposed in any type of environment, setting, or location such as a factory, industrial plant, school, business, home, to mention a few examples. Other examples are possible.

The programmable logic controller 106 is any processing device that executes programmed computer instructions. The access device 108 is in one aspect a single device that is configured to automatically provide, configure, arrange, or set-up (or aid in these functions) a seamless communication path between the control network 101 and the cloud server 114. In part, these functions are provided by the access device 108 exchanging appropriate messages or information with other system elements under a prearranged or preselected communication protocol. In these regards, the access device may include a programmed control element such as a microprocessor that executes programmed software instructions.

The Wi-Fi router 110 is any type of Wi-Fi router as is known in the art. The cellular network 112 is any type of cellular network that is known in the art and may include routers, switches, base stations, and other elements. The cloud network 113 is any combination of appropriate networks. The cloud server 114 is any server disposed at the cloud network 113 and may be implemented as any combination of hardware and software.

In one example of the operation of the system of FIG. 1, a seamless and secure communication path from the control network 101 to a cloud server 114 is created. The cloud server 114 is coupled to the control devices 102 or 104. Tag information from the control network 101 and PLC 106 (e.g., from the PLC 106, and control devices 102 and 104) is obtained. The tag information includes one or more programmed variables associated with the PLC 106 and control devices 102 and 104 controlled by a control system. The tag information is seamlessly and automatically uploaded from the control network 101 to the cloud server 114 via the seamless communication path that extends through the PLC 106 and access device 108 according to at least one predetermined criteria.

In some examples, the predetermined criteria may be a time frequency to upload the information, or a time of day to upload the information. Other examples are possible including having the actions determined by the access device 108.

In other aspects, the information is received at the cloud server 114, the data is evaluated, and an action is taken based upon the evaluating. In some examples, the action may be sending an email, generating a report, or issuing an alarm message to the user 116. In these regards, the user 116 may operate a portable device or interface (such as a personal computer, or cellular phone) to receive these messages. Other examples of actions are possible.

In some aspects, the variables include a variable associated with a machine characteristic. For example, the control device 102 or 104 may be a machine and the machine characteristic may be a temperature, a pressure, a frequency, a time, a yield, an electrical characteristic, or a machine state. Other examples are possible.

In other aspects, the cloud server 114 is configured to be accessible to users via an internet connection. In other example, the tag information includes a time stamp. The time stamp may indicate the time the information was obtained from one of the control devices 102 or 104, or the PLC 106.

In some examples, the seamless and secure connection utilizes at least one of a cellular (via the cellular network 112) or Wi-Fi connection (via the Wi-Fi router 110). In other examples, PLC tag information may be obtained by manually (or in other cases automatically) configuring a set of criteria to select the PLC tag information and the PLC tag information is obtained according to the criteria. For example, the user 116 may indicate this information using any appropriate interface at any type of appropriate device. In still other examples, the criteria may be a number of tags to obtain information and a frequency for how often the information is to be obtained. The system shown in FIG. 1 and described herein in one aspect shows a traditional Local Area Network (LAN) connection in addition to the wireless topologies indicated.

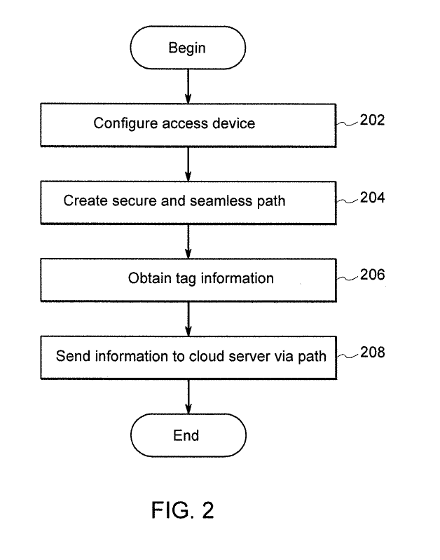

Referring now to FIG. 2, one example of an approach for seamlessly uploading tag information is described. At step 202, an access device (e.g., the access device 108 of FIG. 1) is configured. By “configured” and as used herein, it is meant that the device is loaded with the required parameters to interface/talk to the PLC 106 and the control devices 102 and 104 as well as information concerning tag addresses, tag count, and frequency of cloud uploads (to mention a few examples).

At step 204, a secure and seamless path is created between a control network to a cloud server. The control network includes one or more control devices. The path is made through, for example, a PLC, the access device, and then through a secure connection to the cloud network.

At step 206, tag information is obtained from the control devices. In one example, the PLC obtains the tag information. In one example, the tag information is associated with a variable and the variable is associated with a machine characteristic. The machine characteristic may be a temperature, a time, a pressure, a frequency, a yield, an electrical characteristic, and a machine state. Other examples are possible. Tag information can be obtained from a Modbus device and other field devices.

At step 208, the tag information is sent to a cloud server in a cloud network. The cloud server can provide more processing of the information. The ability to perform processing and analytics at the gateway level may be enabled as well.

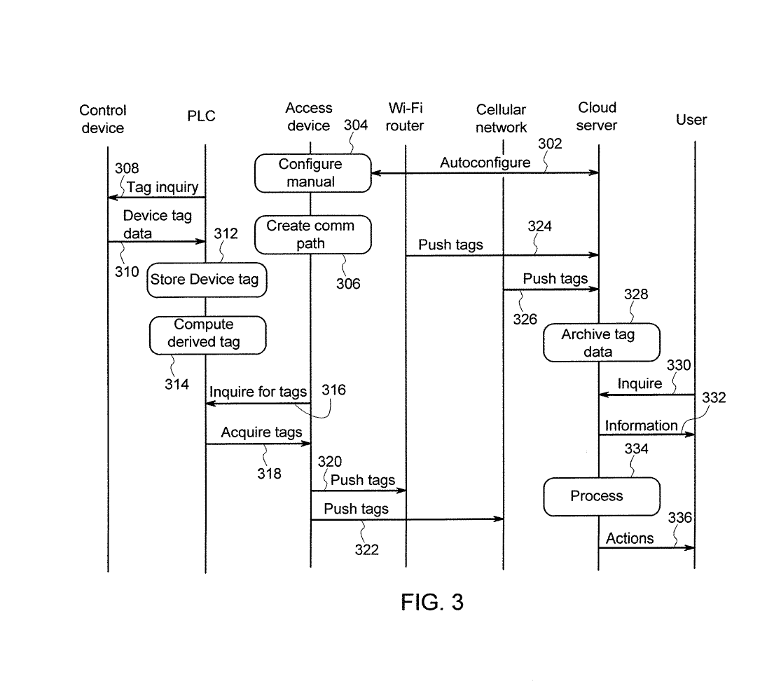

Referring now to FIG. 3, one example of the operation of the system described herein is described. At step 302, automatic configuration commands are exchanged between the cloud server and access device to configure the access device at step 304. The function of auto configuration is that the cloud automatically downloads the information upon connection.

At step 306, a communication path is created between the access device and the cloud server. At step 308, a tag inquiry is sent from the PLC to a control device with a tag. The tag information, in one aspect, is associated with a variable and the variable is associated with a machine characteristic. The machine characteristic may be a temperature, a pressure, a frequency, a time stamp, a yield, an electrical characteristic, and a machine state. Other examples are possible.

At step 310, the device tag data is returned from the control device to the PLC. At step 312, the device tag data is stored. At step 314, derived tag information is computed by the PLC. By “derived tag information” and as used herein, it is meant that a further process is used to use the tag information to derive other types of information or data.

At step 316, a tag inquiry message is sent from the access device to the PLC. At step 318, acquired tag information is sent to the access device. It will be appreciated that the tag inquiry message as well as the other messages described with respect to FIG. 3 may be of any appropriate format.

At step 320, tag information is pushed to the Wi-Fi and/or a cellular network. At step 322, the tag information is pushed to the cellular network.

At step 324, the tag information is pushed from the Wi-Fi router to the cloud server. At step 326, the tag information is pushed from the cellular network to the cloud server. It will be appreciated that in this example, both a Wi-Fi router and a cellular network are used, but in other examples only one may be used.

At step 328, the cloud server archives the tag information. At step 330 a user send an inquire message to the cloud server. At step 332, the cloud server may process further tag information.

At step 336, actions are sent to the user. In some examples, the action may be sending an email, generating a report, or issuing an alarm message to the user 116. In these regards, the user 116 may operate a portable device or interface (such as a personal computer, or cellular phone) to receive these messages. Other examples of actions are possible.

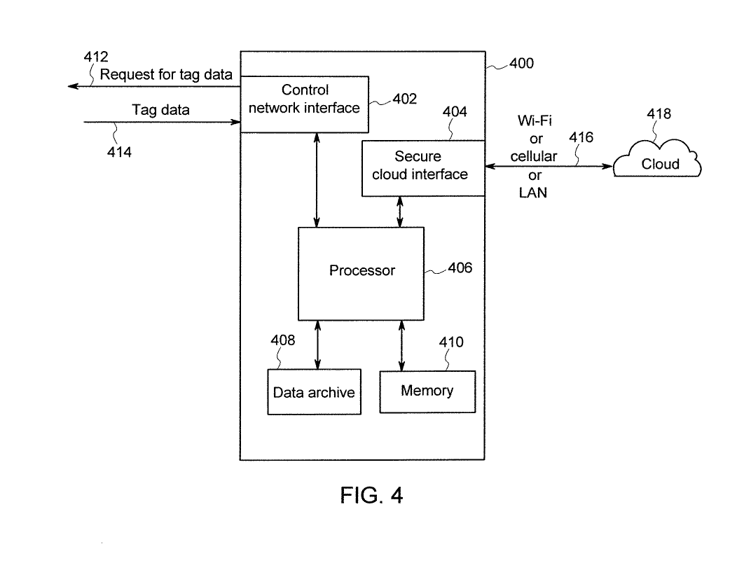

Referring now to FIG. 4, one example of an access device 400 is described. The access device 400 includes a control network interface 402, a secure cloud interface 404, a processor 406, a data archive 408, and a memory 410.

Requests for tag information are sent at an output 414. Responsive to the requests, tag information is received at a first input 412. A network connection 416 connects the device 400 to a cloud 418.

The data archive 408 stores tag data and alarms. The memory 410 may store the programmed computer instructions that are executed by the processor 406. The memory 410 and the data archive 408 may be any appropriate data storage or memory device or combination of devices.

In one example of the operation of the apparatus 400, the apparatus is configured to seamlessly upload tag information from a control network to a cloud server. The processor 406 is coupled to the control network interface 402 and the secure cloud interface 404. The processor 406 is configured to create a seamless and secure communication path from the control network to the cloud server.

The control network is coupled to one or more control devices. The processor 406 is configured to obtain tag information from the control network via the control network interface 402. The tag information includes one or more programmed variables associated with the one or more control devices controlled by a control system. The processor 406 is further configured to seamlessly and automatically upload the tag information from the control network to the cloud server via the seamless communication path created through a secure cloud interface 404 according to at least one predetermined criteria.

It will be appreciated that many of the functions described herein can be implemented using a general purpose processing device that can execute programmed computer instructions. However, it will be appreciated that these functions can be implemented by using any combination of hardware and software elements.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method of seamlessly uploading tag information from a control network to a cloud server, the method comprising:
creating a seamless and secure communication path from a control network to a cloud server, the network coupled to one or more control devices;
obtaining tag information from the control network, the tag information including one or more programmed variables associated with the one or more control devices controlled by a control system;
seamlessly and automatically uploading the tag information from the control network to the cloud server via the seamless communication path according to at least one predetermined criteria.

2. The method of claim 1, wherein the predetermined criteria is a criteria selected from the group consisting of: a time frequency to upload the information, and a time of day to upload the information.

3. The method of claim 1, further comprising receiving the information at the cloud server, evaluating the data, and taking an action based upon the evaluating.

4. The method of claim 3, wherein the action is selected from the group consisting of: sending an email, generating a report, issuing an alarm message.

5. The method of claim 1, wherein the variables comprises a variable associated with a machine characteristic, and the machine characteristic is selected from the group consisting of: a temperature, a pressure, a frequency, a time, a yield, an electrical characteristic, and a machine state.

6. The method of claim 1, wherein the cloud server is configured to be accessible to users via an internet connection.

7. The method of claim 1, wherein the tag information includes a time stamp.

8. The method of claim 1, wherein the seamless and secure connection utilizes at least one of a cellular connection, a Wi-Fi connection, and Ethernet connection, a local area network (LAN) connection, or a cable.

9. The method of claim 1, wherein obtaining tag information comprises manually configuring a set of criteria to select the tag information and obtaining the tag information according to the criteria.

10. The method of claim 1, wherein obtaining tag information comprises automatically configuring a set of criteria to select the tag information and obtaining the tag information according to the criteria.

11. The method of claim 1, wherein the criteria comprises one or more of: a number of tags to obtain information and a frequency for how often the information is to be obtained.

12. An apparatus that is configured to seamlessly upload tag information from a control network to a cloud server, the apparatus comprising:
a control network interface;
a secure cloud interface;
a processor coupled to the control network interface and the secure cloud interface, the processor being configured to create a seamless and secure communication path from a control network to a cloud server, the control network being coupled to one or more control devices, the processor being configured to obtain tag information from the control network via the control network interface, the tag information including one or more programmed variables associated with the one or more control devices controlled by a control system, the processor further being configured to seamlessly and automatically upload the tag information from the control network to the cloud server via the seamless communication path and the secure cloud interface according to at least one predetermined criteria.

13. The apparatus of claim 12, wherein the predetermined criteria is selected from the group consisting of: a time frequency to upload the information, and a time of day to upload the information.

14. The apparatus of claim 12, wherein the cloud server receives the information, evaluates the data, and takes an action based upon the evaluation.

15. The apparatus of claim 14, wherein the action is selected from the group consisting of: sending an email, generating a report, issuing an alarm message.

16. The apparatus of claim 12, wherein the variables comprises variables associated with a machine characteristic, and the machine characteristic is selected from the group consisting of: a temperature, a pressure, a frequency, a time, a yield, an electrical characteristic, and a machine state.

17. The apparatus of claim 12, wherein the cloud server is configured to be accessible to users via an internet or cellular connection.

18. The apparatus of claim 12, wherein the tag information includes a time stamp.

19. The apparatus of claim 12, wherein the seamless and secure connection utilizes at least one of a cellular connection, a Wi-Fi connection, and Ethernet connection, a local area network (LAN) connection, and a cable.

20. The apparatus of claim 12, wherein the criteria comprises one or more of: a number of tags to obtain information and a frequency for how often the information is to be obtained.
